(19) United States
(12) Patent Application Publication
(10) Pub. No.: US 2020/0132482 A1
(43) Pub. Date: Apr. 30, 2020

(54) METHOD AND APPARATUS FOR GENERATING A PARKING SEARCH ROUTE WITHIN A GEOFENCE

(71) Applicant: HERE GLOBAL B.V., Eindhoven (NL)

(72) Inventors: Jerome BEAUREPAIRE, Berlin (DE); Olivier DOUSSE, Lausanne (CH)

(21) Appl. No.: 16/172,393

(22) Filed: Oct. 26, 2018

(51) Int. Cl. G01C 21/34; G08G 1/14; G01C 21/36

(52) U.S. Cl. CPC G01C 21/3461; G08G 1/143; G01C 21/3685; G01C 21/3446; G08G 1/147

(57) ABSTRACT

An approach is provided for generating an optimized parking search route based on prioritizing self-contained driving paths within a geofenced area. The approach involves designating a geofenced area around a destination. The approach also involves calculating one or more routes that are contained within the geofenced area. The approach further involves providing the one or more routes as the parking search route for a vehicle to find a parking space when reaching the destination.

### BACKGROUND

Finding available parking in a large city can pose many challenges. The streets or roads in such areas (e.g., a city center) are often narrow and congested with other vehicles, pedestrians, cyclists, etc. As such, a user or a driver of a vehicle in such areas is often afforded little time to search for parking and/or little time to react to an available parking space or a space that may become available (e.g., a vehicle attempting to pull out of a space). In addition, many streets or roads in such areas have little value for parking and can even force the driver to make unnecessary detours (e.g., a one-way street) that cost time and energy. This problem is even greater where a driver is not familiar with the area, where the user is driving at night or rush hour, where there are many people in the vehicle talking at the same time, etc. For example, a driver can easily become disoriented and make a wrong turn that requires the driver to actually drive away from the destination before being able to return to resume searching for parking. Accordingly, service providers face significant technical challenges to assist users to efficiently find parking in large cities.

### Some Example Embodiments

As a result, there is a need for providing a parking search route that enables a driver to avoid unnecessary detours and delays when looking for parking in a large city.

According to one embodiment, a computer-implemented method for generating a parking search route comprises designating a geofenced area around a destination. The method also comprises calculating one or more routes that are contained within the geofenced area. The method further comprises providing the one or more routes as the parking search route for a vehicle to find a parking space when reaching the destination.

According to another embodiment, an apparatus for generating a parking search route comprises at least one processor, and at least one memory including computer program code for one or more computer programs, the at least one memory and the computer program code configured to, with the at least one processor, cause, at least in part, the apparatus to designate a geofenced area around a destination. The apparatus is also caused to identify one or more road links that lead to exiting the geofenced area. The apparatus is further caused to determine one or more internal road links within the geofenced area that avoid the one or more road links and do not cross a boundary of the geofenced area. The apparatus is further caused to providing the one or more internal road links as the parking search route for a vehicle to find a parking space when reaching the destination.

According to another embodiment, a non-transitory computer-readable storage medium carries one or more sequences of one or more instructions which, when executed by one or more processors, cause, at least in part, an apparatus to designate a geofenced area around a destination. The apparatus is also caused to calculate one or more routes that are contained within the geofenced area. The apparatus is further caused to provide the one or more routes as the parking search route for a vehicle to find a parking space when reaching the destination.

According to another embodiment, an apparatus comprises means for designating a geofenced area around a destination. The apparatus also comprises means for calculating one or more routes that are contained within the geofenced area. The apparatus further comprises means for providing the one or more routes as the parking search route for a vehicle to find a parking space when reaching the destination.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating an optimized parking search route based on prioritizing self-contained driving paths within a geofenced area, according to one embodiment;

FIGS. 2A-2C and 3A-3C are diagrams illustrating an example of generating an optimized parking search route based on prioritizing self-contained driving paths within a geofenced area, according to one embodiment;

FIG. 4 is a diagram of the components of a routing platform, according to one embodiment;

FIG. 5 is a flowchart of a process for generating an optimized parking search route based on prioritizing self-contained driving paths within a geofenced area, according to one embodiment;

FIGS. 6A and 6B are diagrams of example user interfaces for generating an optimized parking search route, according to one embodiment;

FIG. 7 is a diagram of a geographic database, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset or vehicle or part thereof) that can be used to implement an embodiment of the invention.

### DESCRIPTION OF SOME EMBODIMENTS

Examples of a method, apparatus, and computer program for generating an optimized parking search route based on prioritizing self-contained driving paths within a geofenced area are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

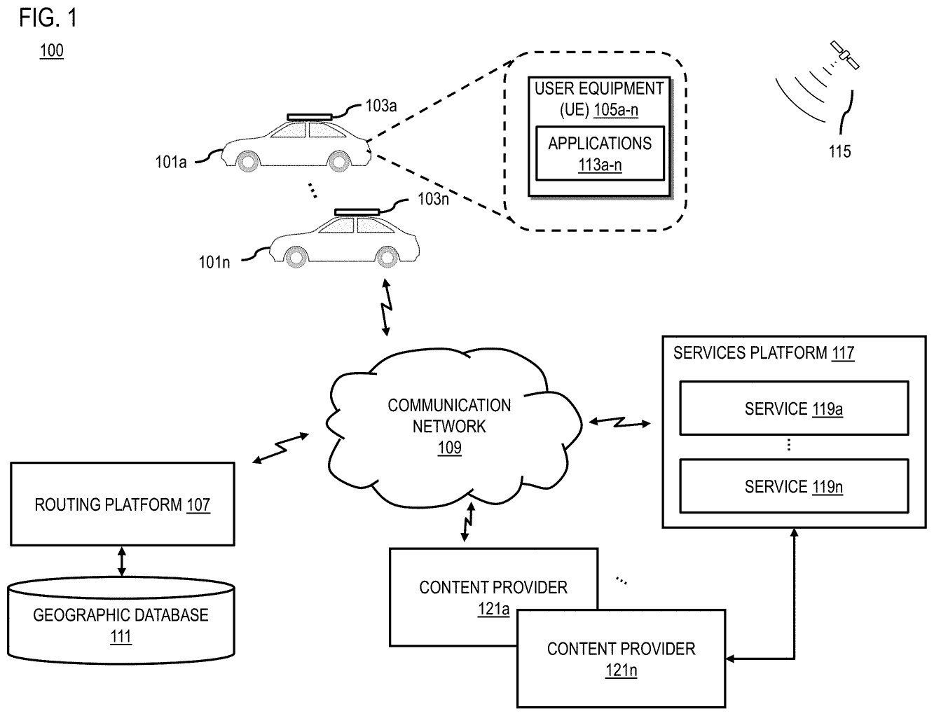

FIG. 1 is a diagram of a system capable of generating an optimized parking search route based on prioritizing self-contained driving paths within a geofenced area, according to one embodiment. Finding parking can be time consuming and frustrating, particularly in large cities (e.g., within a city center) or other similar areas where the number of parking spaces may be limited, the number of drivers simultaneously looking for parking is high, and/or the availability or unavailability of parking spaces changes rapidly. Historically, navigation systems (e.g., embedded car navigation systems) could offer drivers assistance in these situations by indicating parking facilities (e.g., on-street parking, car parks, parking garages, etc.) that are near an intended destination. The presentation of such facilities typically is triggered when a driver or user approaches a known or predicted location. However, if all the parking spots at those parking facilities are occupied, traditional navigation systems generally offer few alternatives other than to suggest other parking facilities.

More recent conventional systems attempt to address this problem by providing “real-time” parking availability data that is estimated from probe data, sensor data, and/or crowd-sourced data. These conventional systems would then typically recommend a parking search route that can maximize the chances that the user or vehicle will find an available parking space. However, because of the dynamic and highly changing nature of parking availability data (e.g., because vehicles may be constantly taking and leaving parking spaces), the delay between collecting the probe data, sensor data, and/or crowd-sourced data and the subsequent calculation of the resulting “real-time” parking availability data may cause the data to become quickly outdated and no longer accurate (i.e., stale). Even in cases where such data can be provided in “real-time,” accessing this “real-time” data typically must be performed over some type of data network (e.g., wireless data network). Therefore, when a data connection to a backend server is not available, a vehicle may not have access to real-time parking availability data.

In the absence of reliable parking data (e.g., parking search routes and/or guidance), users and/or corresponding vehicles may waste valuable resources and time driving on links which have little value for parking and may end up making detours that cost time and energy. In large cities, such detours are more problematic than in residential areas because the roads or links in such areas are usually narrower due to the premium on space and are often more congested with other vehicles, pedestrians, cyclists, etc. all of which make it a challenge for a driver to search for available parking and to react accordingly once a space is found or a space is about to become available. Links that lead to higher functional classification (FC) roads further hinder quickly finding parking because they generally: (1) have more traffic; (2) take more time to insert in (traffic lights, stop sign, etc.); (3) do not provide drivers convenient parking spaces due to higher traffic and stress; do not offer U-turn possibilities (e.g., such maneuvers are prohibited by rule or by space limitations); (4) need to be exited later on at a location that can be farther away from a destination area before the user can come back to the destination area; etc. As a result, these links and the higher FC roads are inherently difficult to navigate and making a wrong turn on such roads can pose further challenges and stress to a driver. For example, a driver confronted with such a link may think to themselves or say to a passenger, “Why did I take this street? I now need to enter this large avenue at the next intersection, it will take me a while at this stop sign behind those waiting cars and this forces me to actually drive away from my destination, so I then need to find a way to drive back to this area . . . .” Therefore, service providers continue to face significant technical challenges to allow drivers looking for parking spaces in large cities to optimize their search by avoiding unnecessary detours and delays.

To address these technical problems, a system 100 of FIG. 1 introduces a capability to generate an optimized parking search route based on prioritizing self-contained driving paths within a geofenced area, according to one embodiment. In one embodiment, self-contained driving paths refer to parking search routes that remain within or primarily within the boundaries of the geofenced area (e.g., by avoiding roads that can potentially take the driver away from a destination or target area). In other words, the driving paths or parking search routes would be “self-contained” within specified geofenced areas (e.g., do not cross or have limited crossing of the geofence boundaries) surrounding a driver's destination or other designated area associated with the destination. The embodiments of the system 100 described herein, for instance, advantageously make the parking seeking experience less frustrating and/or stressful by providing map related insights which can be generated by static and dynamic assets (e.g., digital map data of a geographic database 111). For example, the system 100 can allow drivers looking for parking spaces to optimize their search by avoiding links or roads that may lead them away from the intended destination by providing the self-contained parking search routes or paths generated according to the embodiments described herein. Additional details of these embodiments of the system 100 are discussed below.

In one embodiment, the system 100 of FIG. 1 may include one or more vehicles 101a-101n (also collectively referred to herein as vehicles 101) configured with one or more vehicle sensors 103a-103n (also collectively referred to herein as vehicle sensors 103), one or more user equipment (UE) 105a-105n (also collectively referred to herein as UEs 105) having connectivity to a routing platform 107 via a communication network 109. By of example, the vehicles 101 may be standard vehicles (e.g., a car), autonomous vehicles, or highly assisted driving (HAD) vehicles. Although the vehicles 101 are depicted as automobiles, it is contemplated that the vehicles 101 may be any type of transportation that requires parking (e.g., a car, a truck, a motorcycle, a bike, a scooter, etc.).

In one embodiment, the system 100 computes or otherwise determines a geofenced area around a destination that can support a driver or a user of a vehicle (e.g., a vehicle 101) with “circling inside,” (i.e., providing routes that are self-contained in this geofence). By way of example, the computation of a geofenced area by the system 100 may be advantageous in instances where the destination is near one or more high functional classification (FC) or busy roads that are likely to prevent the driver or the user from quickly finding parking at or near the destination (e.g., due to heavy traffic and/or lacking maneuverability). In one embodiment, the system 100 determines the destination based on a user or a driver of vehicle setting or inputting a destination (e.g., a point-of-interest (POI)) for the user, the vehicle 101, or a combination thereof) using one or more applications 113a-113n (also collectively referred to herein as applications 113) (e.g., a navigation application, a mapping application, a parking application, etc.) associated with the UEs 105.

In one embodiment, once the destination is known by the system 100 (e.g., via a user input), the system 100 can delimit a geofence around the given destination based on one or more high-capacity urban roads that generally have more traffic and/or do not provide drivers with convenient parking. In one embodiment, the system 100 delimits the geofence along one or more roads according to a functional classification or categorization of the roadway based on the character of service they provide such as the functional classification of roads is defined by the United States Federal Highway Administration (FHWA) and/or other equivalent system. For example, under the FHWA or similar functional classification system, the classifications are as follows: FC1=principal arterial roadways; FC2=minor arterial roadways; FC3=collector roadways; FC4=local roads; and FC5=minor local roads, etc.). In one embodiment, the system 100 delimits the geofence along the one or more roads above a determined traffic level/parking convenience threshold. By way of example, the system 100 may delimit the geofence using the one or more roads with the highest classification relative to the destination since these roads are unlikely to yield available parking without considerable delay. In one instance, the delimited geofence may include links or routes around the destination that fall within more than one classification (e.g., a mix of principal and minor arterial roadways or a mix of arterial and collector roadways). In one embodiment, the system 100 determines the classification or categorization of the roads or routes proximate to the destination based on information or data stored in or accessible via a geographic database (e.g., the geographic database 111), a digital map, or a combination thereof. The functional classification of a route or road is just one way that the system 100 can categorize the character of service. The system 100 may also classify or characterize the roads or routes proximate to the destination based on size, type, purpose, capacity, condition, and/or routine level of traffic on a route for the purposes of designating or delimiting the geofence; however, there may be any number of ways to differentiate the roads or links surrounding or around a given destination relative to parking (e.g., side of street parking, length of permitted parking, etc.).

In one embodiment, the system 100 can compute the geofence and/or geofence area based on a maximum and/or a minimum size around or surrounding the given destination. In one instance, the system 100 can compute the geofenced area to include at least one road or link that includes potential parking (e.g., on-street parking or a parking facility). In another instance, the system 100 can compute the geofenced area to include at least one or more roads or links that would permit the user or the driver to search for parking without crossing or entering the delimited FC roads (i.e., “circling inside” one or more roads or links that are self-contained in the geofence). In one embodiment, the system 100 can compute the geofenced area such that when a user or a driver finds parking, they are less than a threshold distance and/or an amount of time away from the destination (e.g., within walking distance).

In one embodiment, the initially computed boundaries of the geofence can evolve into more dynamic boundaries if the system 100 determines that one or more relevant parking related factors have changed and/or are changing during the time that a user or a driver is searching for parking. In one instance, the system 100 may adjust the geofence area based on the one or more routes covered by the user during the parking seeking process. For example, the system 100 may infer that the already covered routes are unlikely to present available parking within a short amount of time given the fact that a user or a vehicle (e.g., a vehicle 101) was already unable to find parking on such routes. Accordingly, the system 100 can contemporaneously modify the boundaries of the geofenced area to exclude these routes. In one embodiment, the system 100 may also recompute the geofence boundary based on the evolution of the parking situations. For example, parking spaces may become available or may be taken during the ending or starting of an event. In one instance, the system 100 can access the starting and/or ending times of an event (e.g., via the geographic database 111) and can adjust the boundaries of the geofenced area accordingly. In one instance, the system 100 can modify the geofence boundary based on traffic conditions (e.g., a known road closure). By way of example, the system 100 can enlarge the area or size of the geofence boundary during periods of high traffic and, therefore, potentially low available parking times (e.g., rush hour) and minimize the area or size of the geofence boundary (e.g., saving time and computational resources) during periods of low traffic and, therefore, potentially normal to relatively high available parking times (e.g., late at night, early in the morning, and/or during the weekends). In one instance, the system 100 may recompute the geofence boundary based on one or more local rules or regulations when the user or driver is searching for parking between two time periods or regimes (e.g., no parking permitted changing to parking permitted or vice-versa).

In one embodiment, once the system 100 computes the geofence area, the system 100 identifies the segments leading to exiting the geofence area. As mentioned above, the links described herein as “to avoid” are links leading to higher FC roads which generally: (1) have more traffic; (2) take more time to insert in (traffic light, stop sign, etc.); (3) do not provide drivers with convenient parking spaces due to higher traffic and stress; (4) do not offer U-turn possibilities; (5) need to be exited later on at a location that can be farther away from a destination area before the user can come back to the destination area, etc. In general, these roads are to be avoided because the likely consequence of driving on such roads is encountering traffic, delays, and/or difficulty finding parking.

In one embodiment, after the system 100 identifies the segments leading to exiting the geofenced area, the system 100 can compute one or more routes that support or enable the user or driver to remain within the geofence area by avoiding the segments that lead to exiting the geofenced area. In other words, the one or more routes are self-contained in the geofence area. By way of example, it is contemplated that these self-contained roads relative to the higher FC roads have less traffic and/or less requirements in terms of forcing a user or driver away from the destination, making it easier and/or less stressful for a user or driver to find parking at or near the given destination. In one instance, the system 100 computes the one or more routes by prioritizing higher the other segments or self-contained segments to be visited within the geofence (all other things being equal). For example, it is contemplated that the chances to find a parking spot are equal on each link.

In one embodiment, if the system 100 determines that all “internal” links have been “explored/visited” by a user or driver of a vehicle (e.g., a vehicle 101), and the driver has still not found parking, then the system 100 can provide the driver with the next best route that allows leaving the geofence area and subsequently coming back. By way of example, the system 100 may determine that a vehicle 101 has already explored all the internal links based on one or more vehicle sensors 103 (e.g., GPS sensors) that may be used to obtain geographic coordinates from one or more satellites 115. In one instance, it is contemplated that by leaving the geofence and coming back, enough time may have elapsed that the parking conditions within the geofenced area will have improved; a driver may be able to gain access to a road or a link that was previously inaccessible (e.g., a one-way street) to approach the destination from a different direction; etc. In one embodiment, once the user has explored the geofenced area, the system 100 can present a new parking search route that includes an adjacent area with similar attributes. In one embodiment, the system 100 may generate a parking search route that includes the segments leading to the higher FC roads once the rest of the area has been “explored/visited.” In other words, the system 100 may include such segments as a parking search route of last resort.

In one embodiment, the system 100 can provide the user or driver of a vehicle (e.g., a vehicle 101) with a parking search route that takes into account the key elements mentioned above to remain inside a geo-fenced area. In one instance, a parking search route may be provided to a user or a driver by showing the user or the driver on a human machine interface (HMI) what are the boundaries of such a geofence and letting the user virtually navigate/explore those boundaries. For example, a UE 105, a HMI, or a combination thereof may include an augmented reality (AR) and/or two-dimensional (2D)/three-dimensional (3D) view or display for such purposes. In one embodiment, the system 100 may provide the parking search route to the user or the driver by only showing the segments “to avoid” when possible on the HMI. In one embodiment, the system 100's showing of the boundaries of such a geofence can enable the user to navigate/explore the geofence boundaries, the area, destination, or combination thereof ahead of the journey, during the journey, or even after (e.g., to gain valuable insight for future reference).

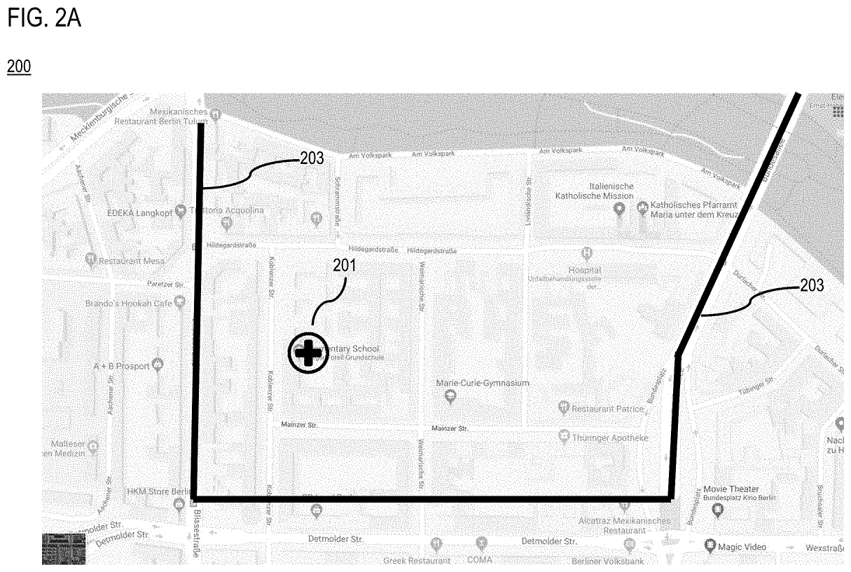

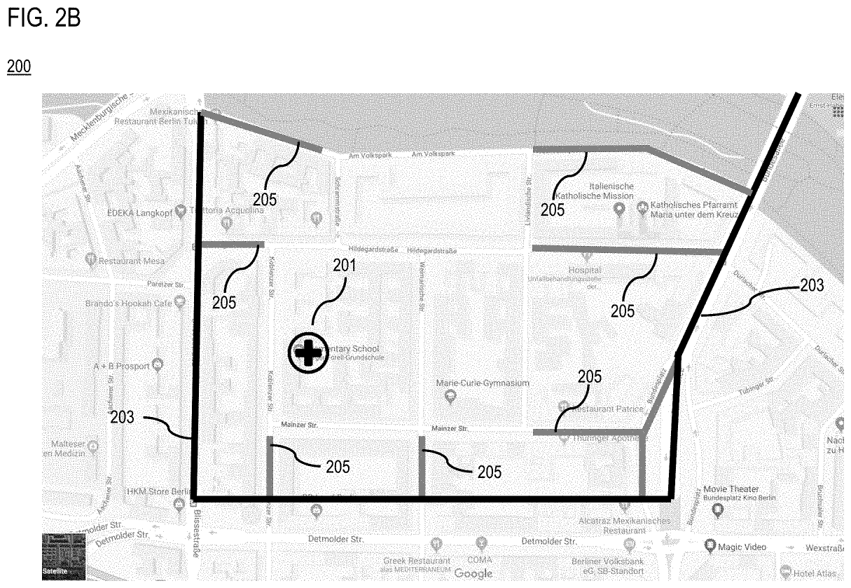

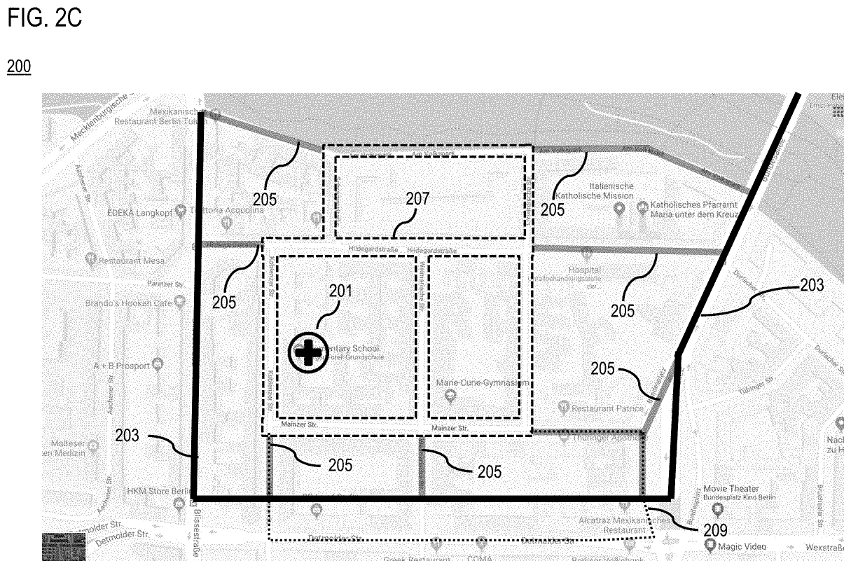

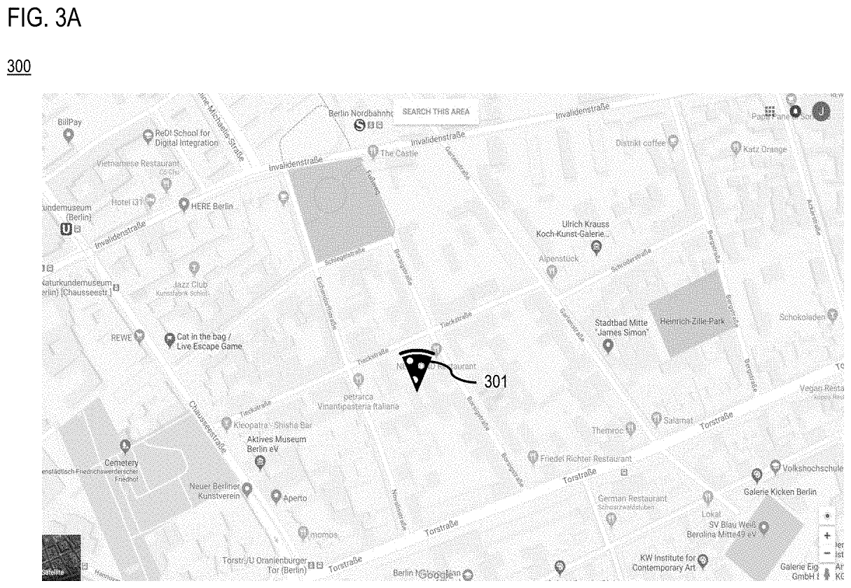

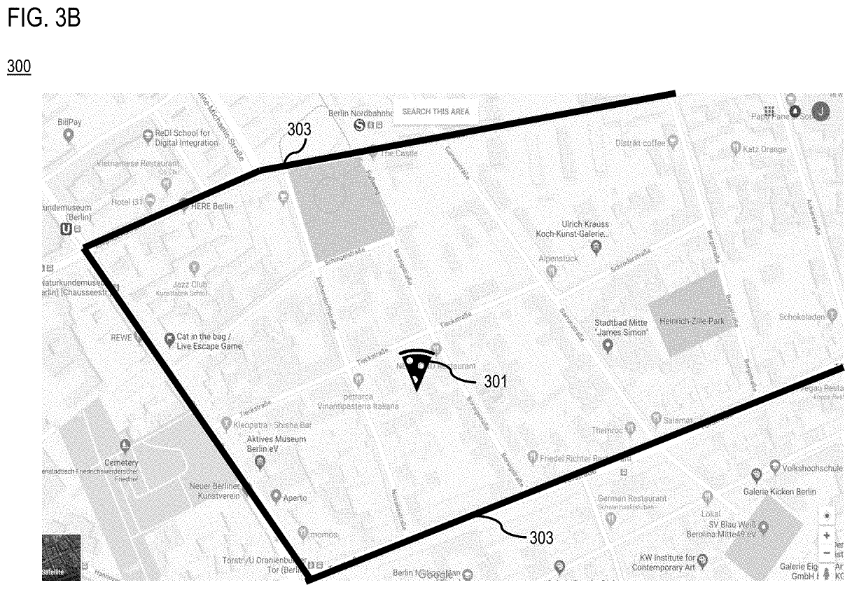

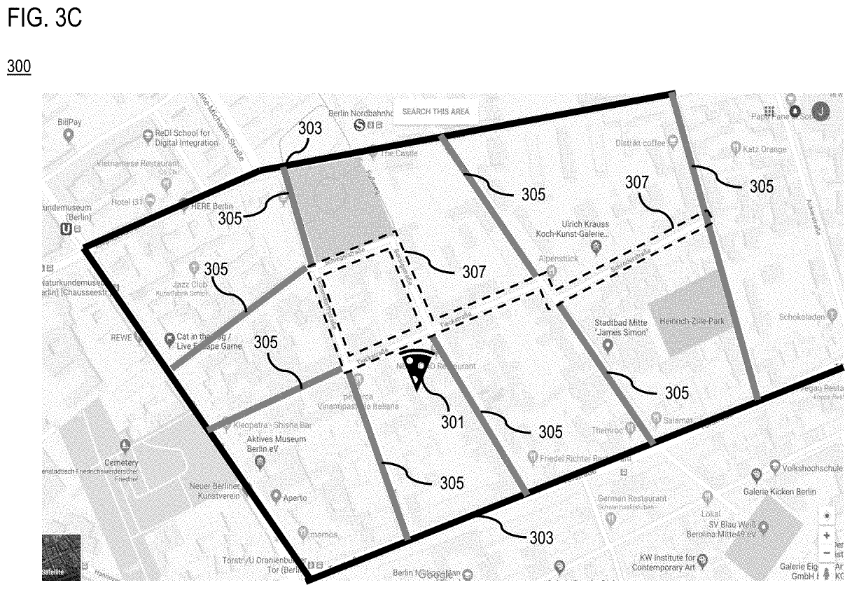

FIGS. 2A-2C and 3A-3C are diagrams illustrating an example of generating an optimized parking search route based on prioritizing self-contained driving paths within a geofenced area, according to one embodiment. As described above, in one embodiment, a user or a driver of a vehicle (e.g., a vehicle 101) may set a destination (e.g., a POI) that the user or the drive wants to park at or near. In this example, the destination 201 of area 200 (e.g., a city center) of FIGS. 2A-2C is a hospital and the destination 301 of area 300 (e.g., a city center) of FIGS. 3A-3C is a restaurant. By way of example, parking availability near a hospital and/or a restaurant, especially in a large city, is often dynamic and, therefore, difficult to determine ahead of time. In one embodiment, the system 100 computes relevant geofenced areas 203 and 303 around the destinations 201 and 301, respectively, as depicted in FIGS. 2B and 3B. In both examples, the system 100 delimits the geofences 203 and 303 on or along the higher FC roads of the areas 200 and 300, respectively. In both examples, the higher FC roads are wider and busier roads relative to the other roads or routes in the respective areas. Consequently, the higher FC roads are likely to have more traffic and often pose more challenges when attempting to quickly find parking (e.g., due to a lack of easy maneuverability). In both examples, the system 100 designates the geofences 203 and 303 such that they surround the destinations 201 and 301, respectively, on three sides. In one embodiment, the system 100 then identifies the segments 205 and 305 that lead to exiting the geofences 203 and 303, respectively. In one instance, the system 100 computes one or more routes 207 and 307 (e.g., 1-N routes) that enable the user to avoid the segments 205 and 305 and, therefore, remain within the geofences 203 and 303, respectively, while searching for parking. By way of example, “avoiding” in this instance may mean that the one or more routes driven by the user or the driver (e.g., routes 207 and 307) are self-contained within in the geofences 203 and 303, respectively (i.e., the user or driver need not cross or drive on the higher FC roads of the geofences 203 and 303). For example, referring to FIG. 2C, a driver could make one or two different circles around the destination 201 on the routes 207 while looking for parking without having to travel on a segment 205 or drive on or across the geofence 203. Similarly, referring to FIG. 3C, a driver could make a circle adjacent to the destination 301 on the routes 307 without having to travel on a segment 305 or drive on or across the geofence 303. In one embodiment, if the user or the driver has already searched or explored all “internal” links (e.g., segments 203 and routes 207), then the system 100 can provide the user or the driver with the next best route that allows the user or driver to leave the geofence 203 and come back shortly thereafter (e.g., route 209).

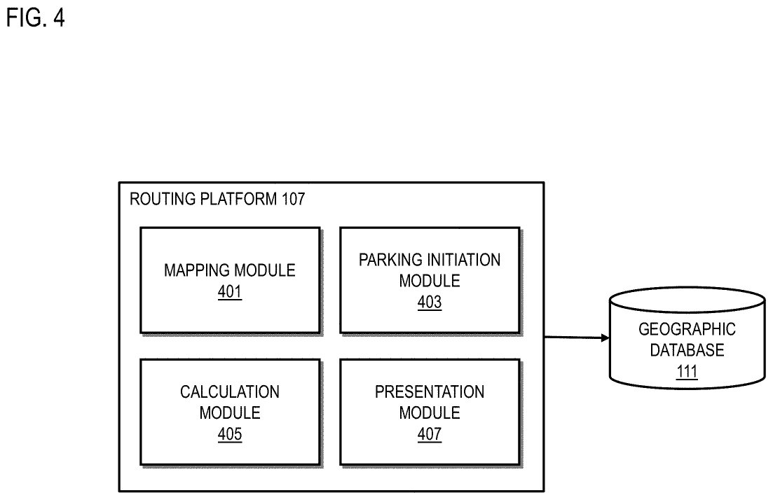

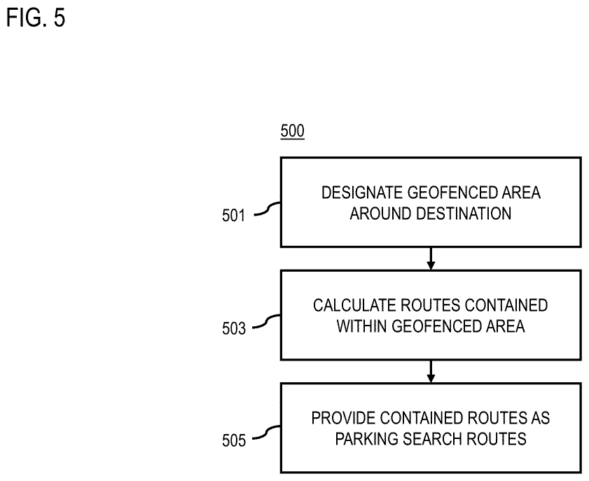

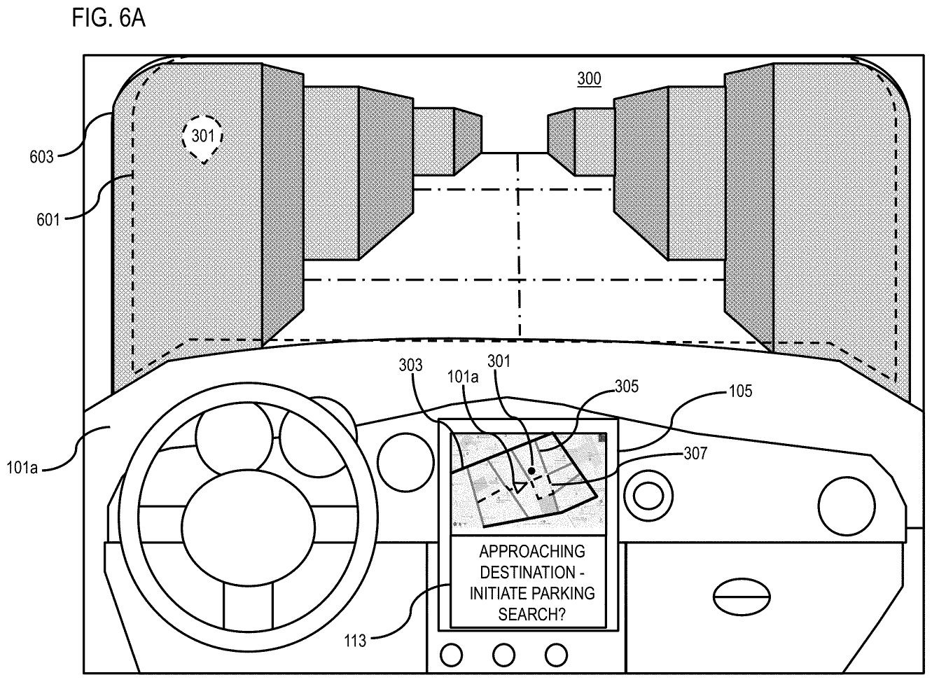

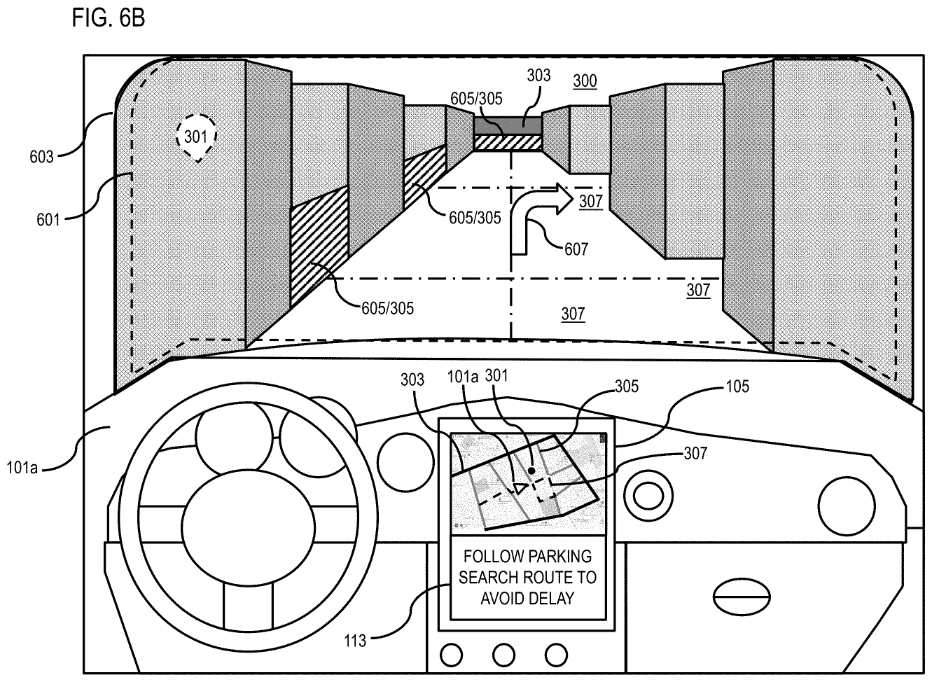

FIG. 4 is a diagram of the components of the routing platform 107, according to one embodiment. By way of example, the routing platform 107 includes one or more components for generating an optimized parking search route based on prioritizing self-contained driving paths within a geofenced area. It is contemplated that the functions of these components may be combined in one or more components or performed by other components of equivalent functionality. In one embodiment, the routing platform 107 includes a mapping module 401, a parking initiation module 401, a calculation module 405, and a presentation module 407 with connectivity to the geographic database 111. The above presented modules and components of the routing platform 107 can be implemented in hardware, firmware, software, or a combination thereof. Though depicted as separate entities in FIG. 1, it is contemplated that the routing platform 107 may be implemented as a module of any of the components of the system 100. In another embodiment, the routing platform 107 and/or one or more of the modules 401-407 may be implemented as a cloud-based service, local service, native application, or combination thereof. The functions of the routing platform 107 and/or the modules 401-407 are discussed with respect to FIGS. 5, 6A, and 6B below.

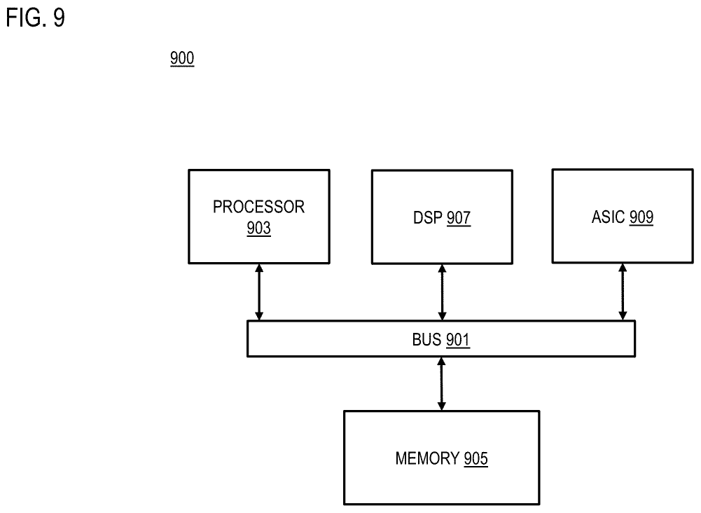

FIG. 5 is a flowchart of a process for generating an optimized parking search route based on prioritizing self-contained driving paths within a geofenced area, according to one embodiment. In various embodiments, the routing platform 107 and/or the modules 401-407 may perform one or more portions of the process 500 and may be implement in, for instance, a chip set including a processor and a memory as shown in FIG. 9. As such, the routing platform 107 and/or modules 401-407 can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

In step 501, the mapping module 401 designates a geofenced area around a destination (e.g., a POI without parking or with limited parking). By way of example, the geofenced area is a zone, a perimeter, and/or a boundary set or assigned around or surrounding the destination (e.g., a store, a restaurant, a movie theater, a hospital, etc.). In one instance, the designated boundary supports a user or a driver of vehicle (e.g., a vehicle 101) “circling inside” the geofenced area while looking for parking at or near the destination. In one embodiment, the mapping module 401 delimits or sets the geofence on or along the higher FC roads (e.g., the largest and/or busiest roads) surrounding the destination. In one instance, the mapping module 401 may enclose or surround the destination with the geofence on all sides, on three sides, on opposite sides, or a combination thereof. In one embodiment, the number and proximity of higher FC roads to the destination determines the specific shape of the geofence and/or the geofenced area. In one instance, where a large city is bordered by a natural cut (e.g., mountains, parks, rivers, deserts, sparse areas, etc.), the mapping module 401 may designate a geofence boundary on only one side of the destination (e.g., opposing the natural cut). In general, the high or higher FC roads are roads or routes within the area (e.g., a city center) that routinely have or handle more traffic; take more time to insert in; do not provide drivers with convenient parking spaces; do not offer U-turn possibilities; and/or need to be exited later on away from the destination to come back to the destination.

By way of example, a destination may be any POI in a large city (e.g., a city center) that a user or driver of a vehicle (e.g., a vehicle 101) may want to park at or near. In one instance, the POI may be a home, an office, a restaurant, a hospital, a shop, a park, a playground, a museum, a sporting or entertainment venue, etc. In one embodiment, the parking initiation module 403 first determines that a user of a vehicle and/or a vehicle (e.g., a vehicle 101) has initiated a search for a parking space. By way of example, an autonomous vehicle 101 may initiate a search for a parking space based on its determined location relative to the destination (e.g., based on GPS sensors 103/satellites 115). In one instance, the user or the vehicle 101 may initiate the search at the start of a journey, during the journey, near or proximate to the destination, or a combination thereof. It is contemplated that the parking initiation module 403 can use any means to determine when the vehicle 101 has started a parking search. For example, the parking initiation module 403 can receive a manual input from the user indicating that the user is looking for a parking space (e.g., using a navigation application 113). In another example, the start of a parking search can be determined based on a routing request by the user (e.g., a route to a POI or other destination with parking nearby). In yet another example, the parking initiation module 403 can collect and process trajectory or probe data from the vehicle 101 and/or vehicle sensors 103 to analyze for parking related behaviors (e.g., looping or circling over the same set of streets, slowing down, etc.).

In one example use case, a user or a passenger of the vehicle 101 may be looking to see if there is any on-street parking near a destination. In large cities due to the value of real estate, many destinations do not have parking as may be in the case in less metropolitan areas (e.g., suburban areas). In one embodiment, the parking initiation module 403 can determine that a user or a passenger of the vehicle 101 has started searching for a parking space based on an initiation of an application 113 (e.g., a parking application, a navigation application, a mapping application, etc.) executing on a UE 105 such as a mobile device, an embedded navigation system, and/or the like. In addition or alternatively, the parking initiation module 403 can determine that a user or vehicle 101 has started searching for parking based on a combination of one or more vehicle related inputs (e.g., location, speed, direction, etc.). For example, the parking initiation module 403 can determine that a vehicle 101 is driving much slower than the known speed limit near the intended destination. In one instance, the parking initiation module 403 can determine that a user or a vehicle 101 has started searching for parking based on a comparison of one or more temporal parameters (e.g., a time of day or a day of the week), location information, and/or one or more entries in an application 113 (e.g., a doctor's appointment, a grocery or to-do list, etc.).

In step 503, the calculation module 405 calculates one or more routes that are contained within the geofenced area. In one embodiment, the calculation module 405 first identifies road links that lead to exiting the geofenced area or would make the driver exit the geofence (e.g., one-way roads). By way of example, the road links may be thought of as the “spokes” of a geofence “wheel.” As previously mentioned, these links are to be avoided when searching for parking because such links and/or the geofence that they are connected to are likely congested and/or restrictive in terms of freedom of travel and as such likely to cause a user or driver of a vehicle unnecessary detours and delays. Consequently, in one embodiment, the calculation module 405 calculates the one or more routes that avoid the identified road links.

In one embodiment, the calculation module 405 then determines the internal road links within the geofenced area that do not cross a boundary of the geofenced area. Specifically, the internal road links may provide a driver with a route that does not lead to entering, driving on, or driving across the higher FC roads that comprise the geofence. As a result, a user or a driver of a vehicle (e.g., a vehicle 101) can circle around or drive around the destination while searching for parking with a relatively low chance of encountering the detours and the delays that are often associated with the higher FC roads or the links leading to such roads.

In one embodiment, the calculation module 405 can calculate the one or more routes dynamically in response to the mapping module 401 designating a dynamic geofence (e.g., one that evolves due to one or more contemporaneous parking related factors). By way of example, the mapping module 401 may adjust the geofenced area based on a route covered by a vehicle (e.g., a vehicle 101) during a parking search. In one instance, the mapping module 401 may adjust the geofenced area based on parking availability data associated with the destination, the geofenced area, or a combination thereof. In one example, if the mapping module 401 determines that a large number of parking spaces will become or have already become available (e.g., due to the end of an entertainment or sporting event), the mapping module 401 may contemporaneously expand the geofenced area to take advantage of the additional parking possibilities. Similarly, if the mapping module 401 determines that many parking spaces will likely or have already become unavailable (e.g., due to the start of entertainment or sporting event), the mapping module 401 may contemporaneously reduce the geofenced area to better avoid unnecessary detours and/or delay. The mapping module 401, in one instance, may also adjust the geofenced based on traffic data associated with the destination, the geofenced area, or a combination thereof. By way of example, the mapping module 401 may determine that a road has been closed and/or is highly congested (e.g., from an accident or road closure report). In one instance, the road may not fall within the categorization of a high or higher FC road; however, because the consequence of driving on this road and/or driving on roads that would lead to this road are the same as the high or higher FC roads, the mapping module 401 may delimit the geofenced area along this road as well. Consequently, in one embodiment, the calculation module 405 can dynamically recalculate the one or more routes that are contained within the geofenced area and/or the one or more internal road links that are within the geofenced area in real time, substantially real time, or a combination thereof according to the one or more modifications in the geofenced area made by the mapping module 401.

In step 505, the presentation module 407 provides one or more routes as the parking search route for a vehicle (e.g., a vehicle 101) to find a parking space when reaching the destination. By way of example, the parking search route is intended to enable the user or the driver of a vehicle (e.g., a vehicle 101) to find a parking space without unnecessary detours and delays. As such, the driver needs to be able to circle inside or drive around within the geofenced area without having to leave the area and/or waste time (e.g., sitting in traffic) on relatively higher FC roads. By way of example, reaching the destination in this instance may mean that once parked, the user or the driver can reach the destination within a threshold distance or time (e.g., within walking distance). In one embodiment, the one or more routes are provided to the user or the driver in such a way that they are prioritized over the road links that lead to exiting the geofenced area. In one instance, the presentation module 407 can present the one or more routes as the parking search routes (e.g., in a user interface) through an assignment of color, symbols, or any similar method of differentiation. For example, the presentation module 407 may present the geofence boundary as red, the road links that lead to exiting the geofenced area as yellow, and the internal self-contained road links as green. In one embodiment, the one or more routes are provided to the user or the driver (e.g., in a user interface) to the exclusion of the road links that lead to exiting the geofenced area. In one instance, the presentation module 407 includes the road links that lead to exiting the geofenced area in the parking search route only when the entire geofenced area has been “explored/visited” by the user or the driver of the vehicle (e.g., a vehicle 101) and parking has still not been found.

In one embodiment, if the mapping module 401, for example, determines that a vehicle (e.g., a vehicle 101) has traveled the internal roads during a parking search without finding a parking space, then the calculation module 405 can calculate another route that the presentation module 407 can present to the user that guides the vehicle 101 to exit the geofenced area and then to return back to the geofenced area. It is contemplated that by leaving the geofenced area and coming back, although this comprises some detour and delay, that the parking situation, for example, may have improved in the meantime and, thereby, reducing the potential for stress and frustration while seeking parking (i.e., the benefits outweigh the costs). In another instance, by the leaving the geofenced area and returning, additional streets or roads that were previously unavailable (e.g., one-way streets) may now be available and/or included in the parking search route. In one embodiment, if the mapping module 401, for example, determines that the user or driver of a vehicle (e.g., a vehicle 101) has explored the entirety of the geofenced area without finding parking, then the presentation module 407 may provide one or more routes as the parking search route that includes visiting an adjacent area with similar attributes. It is contemplated that even in the instance where the presentation module 407 provides one or more routes that include visiting an adjacent area, that the user or the driver of the vehicle can still reach the destination within a threshold amount of time (e.g., within walking distance).

FIGS. 6A and 6B are diagrams of a vehicle user interface depicting a simulated optimized parking search route within a geofenced area, according to one embodiment. As shown, the vehicle user interface 601 of FIGS. 6A and 6B (e.g., a head-up display and/or an AR interface) depicts the provision of one or more routes as the parking search route for a driver of a vehicle (e.g., vehicle 101a) or a vehicle 101 (e.g., an autonomous or semi-autonomous vehicle) to find a parking space when reaching a destination (e.g., restaurant 301). The use case of FIGS. 6A and 6B generally follows the example described with respect to FIGS. 3A-3C. In this instance, the routing platform 107 can simultaneously present the relevant portions of the optimized parking search route as a 3D/AR view on the heads-up display 601 or windshield 603 and in an application 113 (e.g., a navigation application) of the UE 105, which in this instance is an integrated dashboard unit.

Referring to FIG. 6A, a driver or a user of the vehicle 101a may be driving into a large city (e.g., a city center 300) to meet friends at the restaurant 301. In addition to the high level of traffic and vehicular congestion often associated with driving in large cities, the driver may not be familiar with the roads, the location of the restaurant 301, and/or they may be running late. In such situations it would be advantageous to have access to an optimized parking search route to avoid unnecessary detours and delays. In this instance, the driver can see in the navigation application 113 that the restaurant 301 is approaching on their left and, therefore, they may want to find parking nearby on the left somewhere. In one embodiment, the routing platform 107 can prompt the driver through the navigation application 113 (e.g., “Approaching Destination”) and can ask the driver whether she or he would like parking assistance (e.g., “Initiate Parking Search?”). In one instance, the routing platform 107 can prompt the user through the vehicle user interface 601 (e.g., a heads-up display) separately and/or in addition to the application 113.

Once the driver or the user initiates the parking search route (e.g., via the application 113), the routing platform 107 can provide an optimized parking search route, as depicted in FIG. 6B. In one embodiment, the routing platform 107 can present virtual barriers 605 (e.g., in the heads-up display 601 or windshield 603) to the driver or the user that advise the driver or the user to avoid the road links 305 that lead to exiting the geofenced area and/or high or higher FC roads 303 (i.e., avoid going to the left towards the destination to find parking). In one embodiment, the routing platform 107 can also present the driver or user with one or more symbols or guides (e.g., the arrow 607) in the heads-up display 601 or windshield 603 to further support or guide the driver to circle around the destination along one or more routes that are self-contained in the geofence 303 (e.g., routes 307)(i.e., turning towards the right seemingly away from the destination). In this example, although it may appear to the driver or the user of the vehicle 101a that the routing platform 107 is directing the driver or the user away from the restaurant 301, the one or more routes 307 to the driver's right are, in fact, determined by the routing platform 107 to be more likely to yield available parking without unnecessary detour and delays, as described above. In one embodiment, the routing platform 107 can present to the user or the driver the boundaries of the geofence 303 on the heads-up display 601 or the application 113 to enable the user to virtually navigate/explore those boundaries in advance of reaching the destination or even after reaching the destination (e.g., to gain helpful insights for a future visit).

Returning to FIG. 1, in one embodiment, the UEs 105 can be associated with any of the vehicles 101 or a person traveling within a vehicle 101. By way of example, the UEs 105 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 105 can support any type of interface to the user (such as “wearable” circuitry, etc.). In one embodiment, the one or more vehicles 101 may have cellular or wireless fidelity (Wi-Fi) connection either through the inbuilt communication equipment or from a UE 105 associated with the vehicles 101. Also, the UEs 105 may be configured to access the communication network 109 by way of any known or still developing communication protocols. In one embodiment, the UEs 105 may include the routing platform 107 to generate and provide an optimized parking search route.

In one embodiment, the routing platform 107 performs the process for generating and providing an optimized parking search route as discussed with respect to the various embodiments described herein. In one embodiment, the routing platform 107 can be a standalone server or a component of another device with connectivity to the communication network 109. For example, the component can be part of an edge computing network where remote computing devices (not shown) are installed along or within proximity of an intended destination (e.g., a city center). In one embodiment, the routing platform 107 has connectivity over the communication network 109 to the services platform 117 (e.g., an OEM platform) that provides one or more services 119a-119n (also collectively referred to herein as services 119) (e.g., traffic/routing services). By way of example, the services 119 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, content providers 121a-121n (also collectively referred to herein as content providers 121) may provide content or data (e.g., navigation-based content such as destination information, routing instructions, POI data, historical data, etc.) to the vehicles 101, the routing platform 107, the UEs 105, the geographic database 111, the applications 113, the services platform 117, and the services 119. The content provided may be any type of content, such as map content, contextual content, audio content, video content, image content, etc. In one embodiment, the content providers 121 may also store content associated with the vehicles 101, the UEs 105, the routing platform 107, the geographic database 111, the applications 113, the services platform 117, and/or the services 119. In another embodiment, the content providers 121 may manage access to a central repository of data, and offer a consistent, standard interface to data, such as a repository of the geographic database 111.

By way of example, as previously stated the vehicle sensors 103 may be any type of sensor. In certain embodiments, the vehicle sensors 103 may include, for example, a global positioning sensor (GPS) for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data (e.g., lights or exhaust associated with a vehicle 101 about to leave a parking spot), velocity sensors, and the like. In another embodiment, the vehicle sensors 103 may include sensors (e.g., mounted along a perimeter of the vehicle 101) to detect the relative distance of the vehicle from lanes or roadways, the presence of other vehicles 101, pedestrians, animals, traffic lights, road features (e.g., curves) and any other objects, or a combination thereof. In one scenario, the vehicle sensors 103 may detect weather data, traffic information, or a combination thereof. In one example embodiment, the vehicles 101 may include GPS receivers to obtain geographic coordinates from satellites 115 for determining current or live location and time. Further, the location can be determined by a triangulation system such as A-GPS, Cell of Origin, or other location extrapolation technologies when cellular or network signals are available. In another example embodiment, the services 119 may provide in-vehicle navigation services.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the routing platform 107 may be a platform with multiple interconnected components. By way of example, the routing platform 107 may include multiple servers, intelligent networking devices, computing devices, components and corresponding software for generating an optimized parking search route based on one or more other vehicle driving paths. In addition, it is noted that the routing platform 107 may be a separate entity of the system 100, a part of the services platform 117, the one or more services 119, or the content providers 121.

In one embodiment, the geographic database 111 stores information regarding one or more roads or links near a destination and/or within a geofenced area (e.g., street geometry data, driving restrictions data, parking restriction data, or a combination thereof). The information may be any of multiple types of information that can provide means for providing navigation-based content (e.g., a parking search route). In another embodiment, the geographic database 111 may be in a cloud and/or in a vehicle 101, a UE 105, or a combination thereof.

By way of example, the vehicles 101, the UEs 105, the routing platform 107, the geographic database 111, the applications 113, the satellites 115, the services platform 117, the services 119, and the content providers 121 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

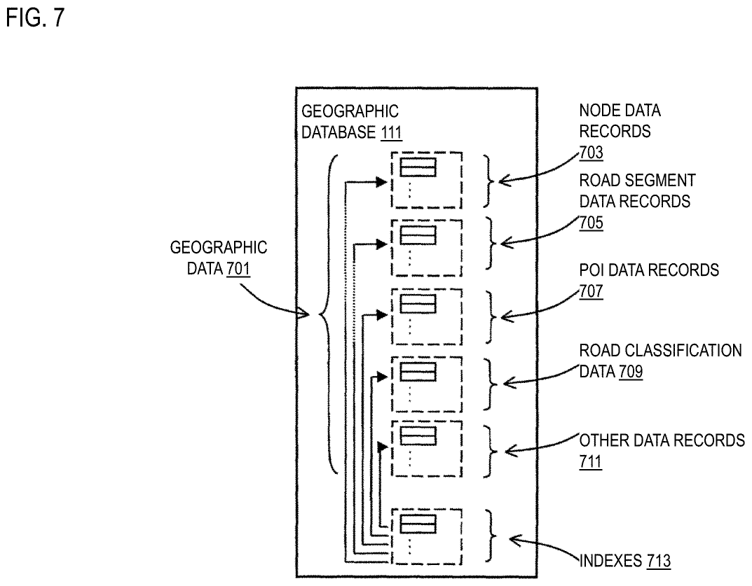

FIG. 7 is a diagram of the geographic database 111, according to one embodiment. In one embodiment, parking search route information and/or any other information used or generated by the system 100 with respect to generating an optimized parking search route based on prioritizing self-contained driving paths within a geofenced area can be stored, associated with, and/or linked to the geographic database 111 or data thereof. In one embodiment, the geographic or map database 111 includes geographic data 701 used for (or configured to be compiled to be used for) mapping and/or navigation-related services, such as for route information, service information, estimated time of arrival information, location sharing information, speed sharing information, and/or geospatial information sharing, according to exemplary embodiments. For example, the geographic database 111 includes node data records 703, road segment or link data records 705, POI data records 707, road classification data 709, other data records 711, and indexes 713, for example. More, fewer or different data records can be provided. In one embodiment, the other data records 711 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. In one embodiment, the POI data records 707 may also include information on locations of traffic controls (e.g., stoplights, stop signs, crossings, etc.), driving restrictions (e.g., speed, direction of travel, etc.), or a combination thereof.

In exemplary embodiments, the road segment data records 705 are links or segments representing roads, streets, or paths, that can be used in determining one or more higher FC roads for designating a geofenced area around a destination, calculating the one or more routes that are contained with the geofenced area, and/or identifying the road links that lead to exiting the geofenced area. The node data records 703 are end points corresponding to the respective links or segments of the road segment data records 705. The road segment data records 705 and the node data records 703 represent a road network, such as used by vehicles, cars, and/or other entities. Alternatively, the geographic database 111 can contain path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as traffic controls (e.g., stoplights, stop signs, crossings, etc.), gasoline stations, hotels, restaurants, hospitals, museums, stadiums, offices, shops, buildings, stores, playgrounds, parks, etc. The geographic database 111 can include data about the POIs and their respective locations in the POI data records 707. The geographic database 111 can also include data about places, such as cities, city centers, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the road classification data 709 can include any data item used to classify or distinguish different types of roads, routes, or links based on size, purpose, ordinary level of traffic, etc. (e.g., a functional classification). In one instance, the road classification data 709 can also include any data related to a status of a road or a route (e.g., based on a road closure report).

The geographic database 111 can be maintained by the content providers 121 in association with the services platform 117 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data or geospatial information is compiled (such as into a platform specification format (PSF) format) to organize and/or configure the data for performing map or navigation-related functions and/or services, such as map annotation, route calculation, route guidance, map display, speed calculation, distance and travel time functions, and other functions, by a navigation device, such as by a UE 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., a UE 105) to provide navigation-related functions. For example, the geographic database 111 can be used with the end user device to provide an end user with navigation features. In such a case, the geographic database 111 can be downloaded or stored on the end user device (e.g., a UE 105), such as in the application 113, or the end user device can access the geographic database 111 through a wireless or wired connection (such as via a server and/or the communication network 109), for example.

The processes described herein for generating an optimized parking search route based on prioritizing self-contained driving paths within a geofenced area may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

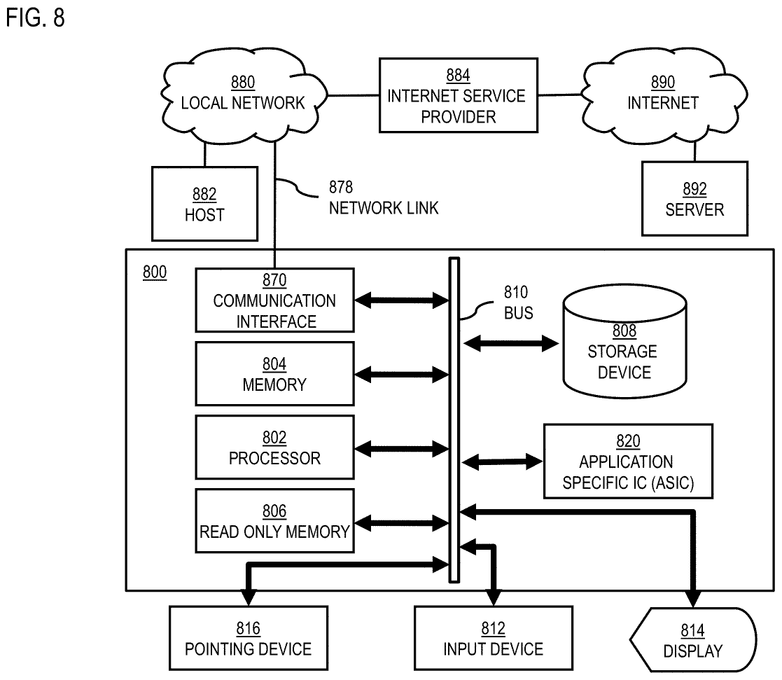

FIG. 8 illustrates a computer system 800 upon which an embodiment of the invention may be implemented. Computer system 800 is programmed (e.g., via computer program code or instructions) to generate an optimized parking search route based on prioritizing self-contained driving paths within a geofenced area as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to generating an optimized parking search route based on prioritizing self-contained driving paths within a geofenced area. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random-access memory (RAM) or other dynamic storage device, stores information including processor instructions for generating an optimized parking search route based on prioritizing self-contained driving paths within a geofenced area. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating an optimized parking search route based on prioritizing self-contained driving paths within a geofenced area, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 109 for generating an optimized parking search route based on prioritizing self-contained driving paths within a geofenced area.

The term non-transitory computer-readable medium is used herein to refer to any medium that participates in providing information to processor 802, including instructions for execution. Such a medium may take many forms, including, but not limited to, non-volatile media, volatile media and transmission media. Non-volatile or non-transitory media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

In one embodiment, a non-transitory computer-readable storage medium carrying one or more sequences of one or more instructions (e.g., computer code) which, when executed by one or more processors (e.g., a processor as described in FIG. 5), cause an apparatus (e.g., the vehicles 101, the UEs 105, the routing platform 107, etc.) to perform any steps of the various embodiments of the methods described herein.

FIG. 9 illustrates a chip set 900 upon which an embodiment of the invention may be implemented. Chip set 900 is programmed to generate an optimized parking search route based on prioritizing self-contained driving paths within a geofenced area as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generate an optimized parking search route based on prioritizing self-contained driving paths within a geofenced area. The memory 905 also stores the data associated with or generated by the execution of the inventive steps.

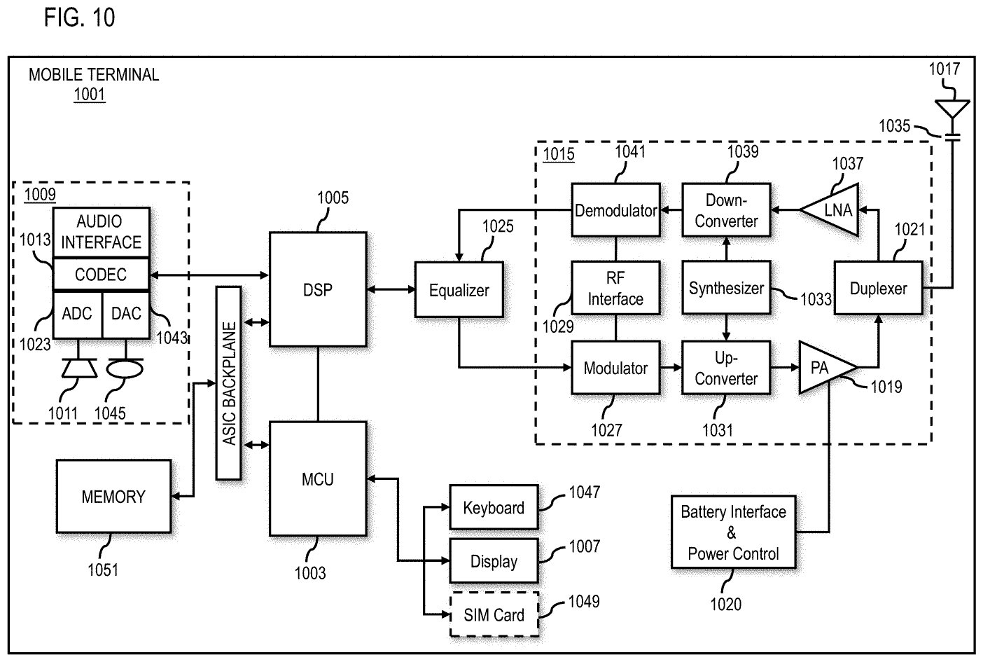

FIG. 10 is a diagram of exemplary components of a mobile terminal 1001 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), WiFi, satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to generate an optimized parking search route based on prioritizing self-contained driving paths within a geofenced area. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable non-transitory computer readable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for generating a parking search route comprising:
designating a geofenced area around a destination;
calculating one or more routes that are contained within the geofenced area; and
providing the one or more routes as the parking search route for a vehicle to find a parking space when reaching the destination.

2. The method of claim 1, further comprising:
identifying road links that lead to exiting the geofenced area;
wherein the one or more routes are calculated to avoid the identified road links.

3. The method of claim 1, further comprising:
determining internal road links within the geofenced area,
wherein the internal road links do not cross a boundary of the geofenced area, and wherein the one or more routes are calculated from the internal road links.

4. The method of claim 3, further comprising:
determining that the vehicle has traveled the internal road links during a parking search without finding the parking space; and
calculating another route that guides the vehicle to exit the geofenced area and then to return back to the geofenced area.

5. The method of claim 1, further comprising:
adjusting the geofenced area based on a route covered by the vehicle during a parking search.

6. The method of claim 1, further comprising:
adjusting the geofenced area based on parking availability data associated with the destination, the geofenced area, or a combination thereof.

7. The method of claim 1, further comprising:
adjusting the geofenced area based on traffic data associated with the destination, the geofenced area, or a combination thereof.

8. The method of claim 1, further comprising:
providing data for generating a user interface depicting the geofenced area, a boundary of the geofenced area, or a combination thereof.

9. The method of claim 8, wherein the user interface is an interactive user interface to explore or virtually navigate the geofenced area.

10. The method of claim 8, wherein the user interface depicts one or more road links to avoid, and wherein the one or more road links lead to exiting the geofenced area.

11. An apparatus for generating a parking search route comprising:
at least one processor; and
at least one memory including computer program code for one or more programs,
the at least one memory and the computer program code configured to, with the at least one processor, cause the apparatus to perform at least the following,
designate a geofenced area around a destination;
identify one or more road links that lead to exiting the geofenced area;
determine one or more internal road links within the geofenced area that avoid the one or more road links and do not cross a boundary of the geofenced area; and
providing the one or more internal road links as the parking search route for a vehicle to find a parking space when reaching the destination.

12. The apparatus of claim 11, wherein the apparatus is further caused to:
determine that the vehicle has traveled the internal road links during a parking search without finding the parking space; and
calculate another route that guides the vehicle to exit the geofenced area and then to return back to the geofenced area.

13. The apparatus of claim 11, wherein the apparatus is further caused to:
adjust the geofenced area based on a route covered by the vehicle during a parking search.

14. The apparatus of claim 11, wherein the apparatus is further caused to:
adjust the geofenced area based on parking availability data associated with the destination, the geofenced area, or a combination thereof.

15. The apparatus of claim 11, wherein the apparatus is further caused to:
adjust the geofenced area based on traffic data associated with the destination, the geofenced area, or a combination thereof.

16. The apparatus of claim 11, wherein the apparatus is further caused to:
provide data for generating a user interface depicting the geofenced area, a boundary of the geofenced area, or a combination thereof.

17. A non-transitory computer-readable storage medium carrying one or more sequences of one or more instructions which, when executed by one or more processors, cause an apparatus to perform:
designating a geofenced area around a destination;
calculating one or more routes that are contained within the geofenced area; and
providing the one or more routes as the parking search route for a vehicle to find a parking space when reaching the destination.

18. The non-transitory computer-readable storage medium of claim 17, wherein the apparatus is further caused to perform:
identifying road links that lead to exiting the geofenced area;
wherein the one or more routes are calculated to avoid the identified road links.

19. The non-transitory computer-readable storage medium of claim 17, wherein the apparatus is further caused to perform:
determining internal road links within the geofenced area,
wherein the internal road links do not cross a boundary of the geofenced area, and wherein the one or more routes are calculated from the internal road links.

20. The non-transitory computer-readable storage medium of claim 17, wherein the apparatus is further caused to perform:
determining that the vehicle has traveled the internal road links during a parking search without finding the parking space; and
calculating another route that guides the vehicle to exit the geofenced area and then to return back to the geofenced area.
